(19) United States
(12) Patent Application Publication
(10) Pub. No.: US 2026/0138165 A1
(43) Pub. Date: May 21, 2026

(54) Method for Treatment of Difficult to Digest Food Wastes

(71) Applicant: Lystek International Corp., Cambridge (CA)

(72) Inventors: Michael BESWICK, Cambridge (CA); Ajay SINGH, Cambridge (CA); Alex WEST, Cambridge (CA); Jim DUNBAR, Cambridge (CA); Basem HAROUN, Cambridge (CA); George NAKHLA, Cambridge (CA)

(21) Appl. No.: 19/392,483

(22) Filed: Nov. 18, 2025

Related U.S. Application Data
(60) Provisional application No. 63/723,203, filed on Nov. 21, 2024.

(51) Int. Cl. B09B 3/30; B09B 3/45; B09B 3/65; B09B 3/70; B09B 101/70

(52) U.S. Cl. CPC B09B 3/30; B09B 3/45; B09B 3/65; B09B 3/70; B09B 2101/70

(57) ABSTRACT

The disclosure is directed at a method of treating hard to digest food waste by treating the food waste with a thermal-alkaline hydrolysis process (THP). The THP includes treating the food waste with heat, alkali, and shear for a preselected time to produce a biodegradable feedstock for improved anaerobic digestion.

### CROSS-REFERENCE TO OTHER APPLICATIONS

The disclosure claims priority from U.S. Provisional Application No. 63/723,203 filed Nov. 21, 2024, which is hereby incorporated by reference.

### FIELD

The disclosure is generally directed at the food industry waste and, more specifically, at a method for treatment of difficult to digest food wastes.

### BACKGROUND OF THE INVENTION

Food wastes are produced by a variety of sources, ranging from agricultural operations to industrial and household food processing. They are typically derived from fruits and vegetables, grain and starch products, dairy, oil and fat, meat, and seafood etc. Wasted food contributes to climate change, with a global carbon footprint of about 8% of total global anthropogenic greenhouse emissions. Annually, an estimated 1.3×10⁹ tonnes of food waste are disposed of to landfills globally, producing 3.3× 10⁹ tonnes of CO₂. A greater diversion of food and other organic waste from traditional disposal (such as landfills and incineration) toward alternative beneficial uses is continually sought.

Animal feeding, composting, and anaerobic digestion (AD) are the other common food waste treatment or recovery methods. Composting is the most common method of managing food waste aerobically, where microbes metabolize organic waste material and reduce its volume by as much as 50 percent. AD is another known biological process under anaerobic conditions, to reduce the volume of food waste and recover biogas and methane for energy.

Addressing the challenges associated with the nexus of food production and utilization, energy, water, waste management, and environmental health requires careful attention to curb the negative impacts of improper handling of food and other organic waste. The valorization of food waste provides numerous environmental benefits, such as reducing greenhouse gas emissions, reducing storage requirements, renewable energy production, and value added environmentally friendly products. However, many obstacles are associated with effective utilization of the organic waste materials. Some of the major factors are heterogeneity of the food and source separated organic (SSO) waste material and the robustness of the plant cell wall resulting in recalcitrant biological degradation.

Categories of food waste can be characterized by their origin, physical properties, and chemical composition. It can be further classified into waste from the dairy, meat and poultry, fish, fruit and vegetable, cereal and bakery, brewing and winery industries, and source separated organics (SSO) from households and restaurants. However, for resource recovery purposes, the most important characteristic refers to the chemical composition of the waste, which represents fermentable substrates for the microorganisms required for the anaerobic digestion process. Compared to other types of substrates used in AD, food waste is generally characterized by a diversity of nutrients favorable to microbial growth. Food waste contains a wide range of micronutrients that include metal ions such as Ca, Na, K, Mg, Fe, Zn, etc., which are necessary elements in small concentrations for microbial growth and activity. Proteins, fats, and sugar content in food waste is directly related to the type of food from which this waste comes. Carbohydrate concentrations are significantly higher in food waste of plant origin, even if the degree of accessibility of the different sugars is not similarly high.

Most of the food waste and SSO substrates contain recalcitrant or hard to degrade or digest fractions or portions, which vary from about 15% to about 50% depending on the organic waste material types such as waste from cereal processing, vegetable and fruit peels, seeds, kernels, etc. This is mainly composed of cellulose, hemicellulose, and lignin, making a complex assembly of polymers naturally recalcitrant to enzymatic or biological conversion. The cellulose chains are made up of glucose units, arranged together to form microfibrils, which are embedded in a lignocellulosic matrix that makes it very resistant to enzymatic hydrolysis and biodegradation. Hemicelluloses are heterogeneous groups of biopolymers with various monosaccharide subunits to form xylans, xyloglucan, mannans, and glucomannans. Hemicelluloses also act as a physical barrier limiting the accessibility of hydrolytic enzymes. Finally, lignin is responsible for hydrophobicity and structural rigidity that binds hemicelluloses to cellulose in the cell wall. The removal of lignin generally disrupts the lignin-carbohydrates matrix. Thus, some type of pretreatment method is required to break the complex structure of these recalcitrant substrates to improve anaerobic digestibility.

AD has been widely used to reduce organic waste output and generate biogas for energy simultaneously, e.g., in wastewater treatment facilities. The AD process includes a series of complex microbiological and biochemical processes that occur in an anaerobic digester through four stages: hydrolysis, acidogenesis, acetogenesis, and methanogenesis. The bacteria involved in the digestion process are sensitive to environmental conditions and it is important to design the digester system to balance a range of factors for achieving efficient operation. The rate-limiting first step, hydrolysis, in the AD process is generally linked to the characteristics of the organic feed material being digested. The hydrolysis performed by the AD is biochemical in nature.

Some organic components may be more easily degradable, slowly degradable, or non-degradable depending on the type of food waste. In the case of slower or harder to degrade substrates some pre-treatment may be required to facilitate the first hydrolysis step for easier enzyme accessibility to the difficult to degrade organic fractions.

Therefore, there is provided a novel method and system for treatment of difficult to digest food waste.

### SUMMARY

The disclosure is directed at a method and system for treatment of difficult to digest food waste. After collecting food waste or source separated organic (SSO) materials, they are treated via a thermal-alkaline hydrolysis process in order to improve the biodegradability of the harder to digest or degrade portions of the food waste or SSO materials.

In one aspect of the disclosure, there is provided a method of treating recalcitrant or hard to degrade organic fractions in digested or undigested food wastes and/or source separated organic (SSO) wastes to create a more biodegradable material including treating the digested or undigested food wastes and/or SSO wastes with heat, alkali, and shear for a preselected time to produce a biodegradable feedstock.

In another aspect, the method further includes performing anaerobic digestion on the biodegradable feedstock. In a further aspect, the treatment temperature is between 70° C. and 90° C. In yet another aspect, the treatment pH is between 8 and 10. In a further aspect, the treatment time is between 1 min and 30 min. In another aspect, the heat, alkali, and shear treatment can be done simultaneously or in a sequence.

In another aspect, the anaerobic digestion time is between 5 days and 30 days. In a further aspect, pre-processing the digested or undigested food wastes and/or SSO wastes occurs before treating the digested or undigested food wastes and/or SSO wastes. In a further aspect, pre-processing the digested or undigested food wastes and/or SSO wastes includes grinding and/or blending the digested or undigested food wastes and/or SSO wastes. In yet another aspect, pre-processing the digested or undigested food wastes and/or SSO wastes includes processing the pre-processing the digested or undigested food wastes and/or SSO wastes into an organic slurry. In yet a further aspect, pre-processing the digested or undigested food wastes and/or SSO wastes includes centrifuging the digested or undigested food wastes and/or SSO wastes into a solid portion and a liquid portion. In a further aspect, treating the digested or undigested food wastes and/or SSO wastes with heat, alkali, and shear includes treating the solid portion.

### BRIEF DESCRIPTION OF THE DRAWINGS

The disclosure will be better understood with reference to the attached drawings, in which:

FIG. 1a is a flowchart of one embodiment of a method for treating hard to digest food waste;

FIG. 1b is a flowchart of another embodiment of a method for treating hard to digest food waste;

FIG. 1c is a flowchart of an embodiment of a method of treating hard to digest source separated organic (SSO) materials;

FIG. 1d is a flowchart of one embodiment of treating hard to digest SSO materials;

FIG. 2 is a flowchart showing one embodiment of a method of a thermal-alkaline hydrolysis process; and

FIG. 3 is a schematic diagram of a thermal-alkaline hydrolysis process reactor.

### DETAILED DESCRIPTION

The disclosure is directed at a method and system for treatment of difficult to digest food wastes. In embodiments, the disclosure includes the application of a thermal-alkaline hydrolysis process (THP) treatment to the food waste or SSO wastes. One example of a THP is described in U.S. Pat. No. 9,260,322 and Canadian Patent No. 2,608,506 which disclose processes for treatment and hydrolysis of sewage sludge using a combination of shearing, heat, and alkali addition. In the following, this process is referred to as the Lystek™ THP although it is understood that other THP may be contemplated.

In other embodiments, prior to the THP, the food waste, which also includes or may be separated organic (SSO) waste or materials, is pre-processed in order to prepare it for treatment via the THP. In some embodiments, the THP treatment occurs within a THP reactor.

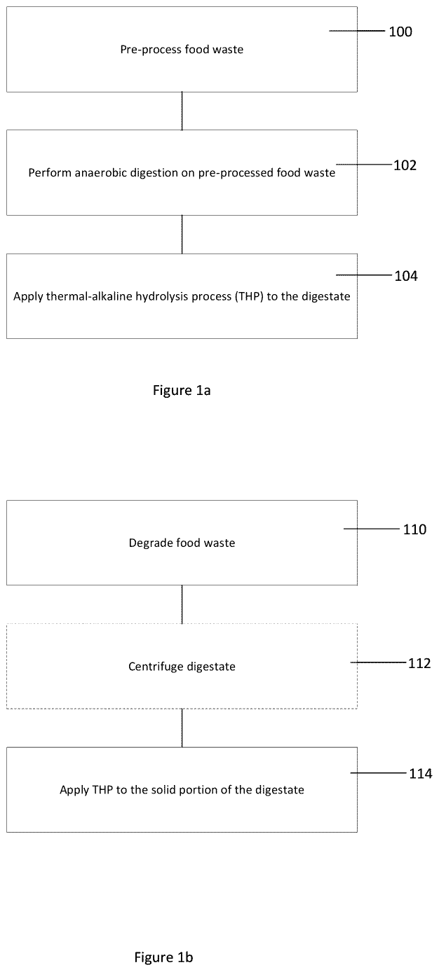

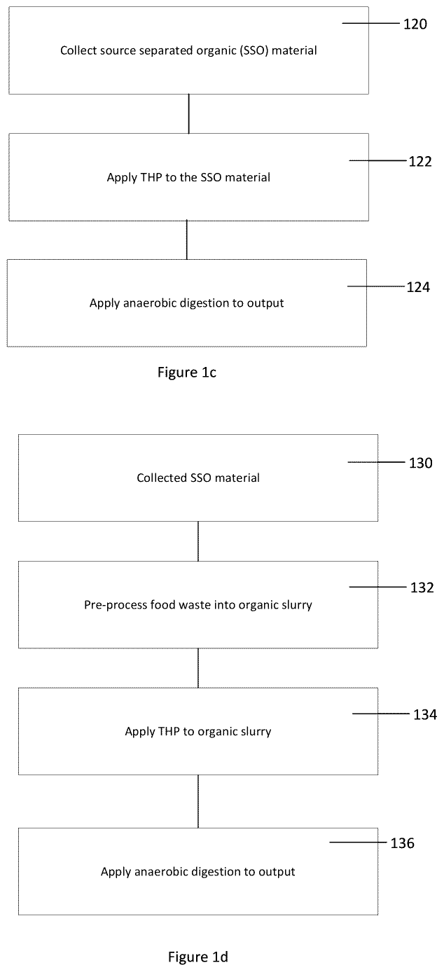

Turning to FIG. 1a, a flowchart showing an embodiment of treating difficult to digest food waste or food wastes is provided. In the current embodiment, food waste is collected and then pre-processed (100). Pre-processing of the food waste prepares the food waste for further treatment. In some embodiments, the pre-processing may include grinding and/or then blending of the food waste to further break down components of the food waste. The pre-processed food waste is then subjected to anaerobic digestion (102) so that more easily degradable organic portions of the pre-processed food waste can biodegrade or be biodegraded.

Anaerobic digestion (AD) is a process to manage organic waste, in which organic matter is biodegraded by the combined action of a highly diverse microbial community including various groups of microorganisms. Anaerobic microorganisms metabolize organic waste and reduce the overall mass, sometimes by as much as 50 percent. During anaerobic digestion, biogas can be recovered for energy through a series of complex microbiological and biochemical processes that occur in anaerobic digesters through four stages: hydrolysis, acidogenesis, acetogenesis, and methanogenesis.

As the food waste undergoes the anaerobic digestion, the pre-processed food waste is separated into the biogas and a digestate, which may also be seen as a set of recalcitrant residual organics. In other words, the digestate can be seen as a difficult to digest portion of the collected food waste.

The digestate is then treated using a thermal-alkaline hydrolysis process (THP) (104), such as, but not limited to, the Lystek THP. In one embodiment, the THP includes processing the digestate with a THP reactor. Application of the THP may be seen as applying a thermochemical hydrolysis treatment to the hard to digest portion of the food waste.

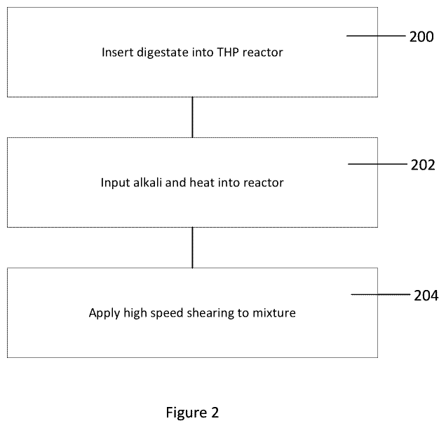

Turning to FIG. 2, which is a flowchart showing one embodiment of a method of THP, after being collected, the digestate (or hard to digest food waste) is inputted into the THP reactor (200). A liquid alkali and heat, such as via steam injection, are then added to the THP reactor (202). In some embodiments, the alkali and heat may be added simultaneously, or the alkali and the heat may be added one before the other in sequence. The amount of alkali and heat that are added depends on the characteristics of the digestate. In some embodiments, the THP occurs around 75° C. at a pH between about 8.5 and 9.5. In other embodiments, the THP occurs within a temperature range between about 70° C. and about 90° C. In yet other embodiments, the THP occurs at a pH between about 8 and about 10.

After the digestate, alkali and heat are added, the mixture is subjected to high-speed shearing within the THP reactor (204) for a predetermined period of time. In some embodiments, the predetermined time period for shearing is about 15 minutes, however, other time periods, such as between about 1 minute to about 30 minutes, are contemplated. The shearing blends the components into a homogeneous mixture resulting in a hydrolyzed product, which can more readily degrade by itself. From experiments, as outlined in more detail below, it was learned that application of the THP to the digestate improved the biodegradability of the digestate or the hard to digest food waste.

Turning to FIG. 1b, a flowchart showing another embodiment of treating difficult to digest food wastes is shown. In this embodiment, food waste is collected and then allowed to degrade (110) for a predetermined period of time. In one embodiment, the degradation of the collected food waste may include performing AD on the food waste to generate or produce a digestate and biogas such as discussed above. The digestate is then collected and the biogas used for other applications.

After collection, in some embodiments, the digestate is then centrifuged (112) in order to separate the digestate into a solid portion and a liquid potion. It is understood that, in some embodiments, depending on the characteristics of the collected digestate, such as, but not limited to, a level of biodegradability of the digestate, there may not be a need to centrifuge the digestate.

The solid portion of the centrifuged digestate or the entire non-centrifuged digestate is then treated using a THP (114) to produce the hydrolysed product.

Turning to FIG. 1c, a flowchart showing another embodiment of treating difficult to digest food wastes is provided. In the current embodiment, the food waste may be seen as SSO materials or hard to biodegrade SSO waste.

After being collected (120), the SSO material or waste, which may also be seen as the digestate, is treated using a THP (122). As described above, in one embodiment, using the THP reactor, the SSO material or waste is placed into the THP reactor for treatment via the THP. An alkali and heat are added to the THP reactor and the components sheared, such as via a high-speed shearing blade, within the reactor to produce the hydrolyzed product which is more readily degradable. The output of the reactor, or the hydrolyzed product, can then be subjected to an AD process, if required, (124) to produce biogas from the hydrolyzed output of the reactor and to further process the food waste.

Turning to FIG. 1d, a flowchart showing yet another embodiment of treating difficult to digest food wastes is provided. In the current embodiment, SSO material, which may be seen as a digestate, is collected (130) and then pre-processed (132). In one embodiment, the SSO material is pre-processed to produce an organic slurry free of inorganic contaminants. In some embodiments, this may be performed in a containerized de-packaging unit. In some embodiments, the de-packaging unit separates non-food waste contaminants, such as, but not limited to, plastics, glasses and other larger debris, from the organic fractions within the SSO material. The organic slurry is then treated via a THP (134) such as described above. The output of the reactor may then be subjected to an anaerobic digestion process (136), if required, to produce biogas from the output of the reactor and to further biodegrade the hydrolyzed product.

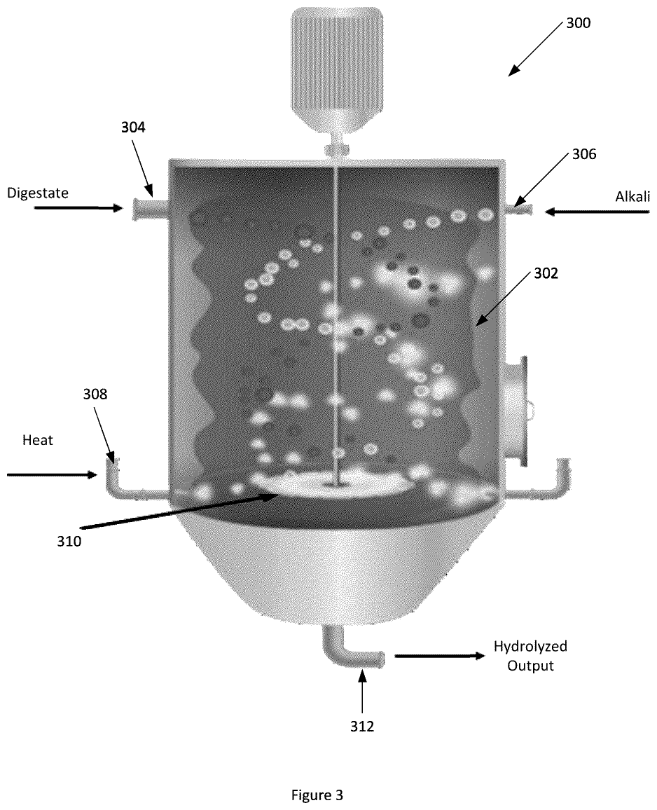

Turning to FIG. 3, a schematic diagram of a reactor for use in a THP is shown. The reactor 300 includes a housing 302 for receiving food waste, such as in the form of a digestate, through an input port or opening 304. The reactor 300 further includes an opening or entry port 306 for receiving a liquid alkali for the THP. An entry port 308 receives heat, such as in the form of steam injection. The reactor 300 further includes a high-speed shearing blade 310 for combining the digestate, the heat and the liquid alkali. After the THP has been completed, a hydrolyzed output exits the reactor 300 through an output port 312.

In some embodiments, when the THP is the Lystek THP, the low temperature Lystek THP disintegrates particulate matter and breaks down cellular components while increasing solubilization of complex organic compounds such as, but not limited to, proteins, lipids, and carbohydrates in organic materials to convert them into simpler compounds that are more amenable to further biodegradation and conversion into value-added products.

Based on experiments, it was determined that the output of the reactor (after the digestate was subjected to the THP) resulted in proteins that were converted into simpler peptides and amino acids, lipids that were converted into fatty acids and other simpler organic acids, and complex carbohydrates that were converted into simpler carbohydrates and sugars. One advantage of the current disclosure is that the thermochemical hydrolysis performed on the digestate during the THP facilitates solubilization and biodegradation of complex organic molecules in anaerobic digesters when AD is performed after THP. This is due to the fact that the input of the hydrolyzed product to the anaerobic digester improves the kinetics of the digestion process resulting in a faster and higher level of biogas production and a reduction in solid products output from the anaerobic digester. The THP may also enhance the hydrolysis step of the AD and also produces some of the organic acids produced during acidogenesis and acetogenesis stages of anaerobic digestion to assist with those stages of AD.

In embodiments where AD occurs before the THP, as some of the food waste cannot be broken down during AD, the THP improves the biodegradability of food waste that has been processed under AD.

In experiments, it was shown that food waste or food waste material which has undergone the THP provides an improved feedstock to digestion, due to homogenization, particle size reduction, carbon solubilization and viscosity reduction. The THP also improves biodegradability, digestion kinetics and biogas yields in anaerobic digesters, where the anaerobic digestion occurs after the THP, while reducing the amount of solids for further management.

In order to quantity or determine an effectiveness of the THP, biochemical or biomethane methane potential (BMP) testing was used. BMP is a well-established technique to determine the ultimate methane yield of organic materials from wastewater, food, and agricultural wastes, etc. using anaerobic bacterial culture at a lab scale. Thus, a BMP test provides an indication of a food waste's biodegradability and associated methane production. It can be described as a method to evaluate the quantity of organic carbon in a particular substrate that can be converted to methane. Also, it can be defined as the maximum or a high quantity of methane produced by a substrate per mass of the substrate's organic matter expressed as volatile solid (VS) or chemical oxygen demand (COD). It denotes the methane produced per unit of volatile solid (VS) or per unit of chemical oxygen demand (COD) at standard temperature and pressure. Biodegradability of the substrate can be calculated by dividing measured cumulative methane volume by theoretical cumulative methane volume (1 g COD=0.35 L CH₄).

In one experiment using the method of FIG. 1a, a mixture of food waste was collected from a waste resource recovery facility. After collection, the food waste was pre-processed by grinding the food waste using a metal food grinder and then homogenized using a blender. The mixture was then stored at about 4° C.

The food waste was then subjected to anaerobic digestion at a mesophilic temperature (37° C.) for 16 days at an initial pH 7.0-7.2 using seed inoculum from a municipal wastewater treatment plant anaerobic digester. During this period, it was observed that most of the easily degraded organic fraction was biodegraded.

Digestate samples were collected and separated into different portions. One, or a first, portion was treated using the THP at a temperature of about 75° C. and pH of about 8.5 to about 9.5. Another, or second, portion was used as an untreated control to determine the impact of the THP treatment on the digestate sample or recalcitrant undegraded fraction of the food waste.

Both the untreated digestate samples (second portion) and samples subjected to the thermal-alkaline hydrolysis process treatment (first portion) were subjected to BMP tests set up with an automated methane potential test system at 37° C. for 12 days at an initial pH of about 7.0 to about 7.2. It was observed that there was a substantial improvement in the biodegradability (which was measured at 81%) of the treated digestate (first portion) compared to the biodegradability (which was measured at 26%) for the untreated digestate (second portion).

The methane yield (284 mL/g COD) of the THP treated digestate food waste was substantially higher than the untreated digestate food waste (90 mL/g COD). Therefore, it was concluded that the digestate that was treated using the THP had an improved biodegradability and methane production of recalcitrant organic fractions.

The characterization and methane yield of the THP digestate and the untreated digestate samples are presented in Table 1. Soluble COD level in the THP treated digestate was significantly higher compared to the untreated digestate material. Soluble COD is an indicator of solubilization of compounds and the presence of readily biodegradable substrate in organic waste material.

TABLE 1
Characterization and BMP test results
on untreated and THP treated food waste

| Sample | Untreated digestate | Lystek treated digestate |
|---|---|---|
| TS (mg/L) | 17,110 | 20,448 |
| VS (mg/L) | 9,410 | 9,325 |
| Total COD (mg/L) | 13,645 | 12,615 |
| Soluble COD (mg/L) | 538 | 1,765 |
| CH₄ yield (mL/g COD) | 90 | 284 |
| Biodegradability (%) | 26 | 81 |

In experiments using the method of FIG. 1b, anaerobic digestion of collected food waste was carried out in a 9-L continuously stirred tank reactor (CSTR) for 103 days under mesophilic conditions, at an organic loading rate (OLR) ranging from 3.2 to 9.2 g COD/L/d, and solids retention time (SRT) ranging from 14.2 days to 20.6 days. Digestate samples were collected from the CSTR after the collected food waste was substantially degraded (73-77%) for 81 to 103 days and kept in a cold room (4° C.) for further investigation using BMP tests.

Two BMP tests were carried out at mesophilic temperature (37° C.) and initial pH 7.0. BMP test 1 was conducted with the digestate collected from the CSTR between day 81 and 100 when the food waste biodegradability in the CSTR was 73%, and BMP test 2 was performed with the digestate solids collected at the end of the CSTR run (day 100-103) when the food waste biodegradability was 77%. For the tests, the digestates were separated into two portions with one portion being treated with a THP while the other portion was untreated.

In BMP test 1, a portion of the digestate was treated with the THP before inoculation and the BMP test was conducted for the THP treated digestate portion and the untreated digestate portion. The results demonstrated that the THP improved digestion of non-degradable food waste by about 35% (131 mL CH₄/g COD for the treated digestate versus 97 mL CH₄/g COD for untreated digestate).

In BMP test 2, the digestate was first centrifuged to concentrate the material, then the THP was applied to a portion of the solid fraction. A BMP test was conducted with both the THP treated digestate and untreated digestate. BMP test 2 results demonstrated an about 22% improvement in the digestion of organics in the THP treated digestate (116 mL CH₄/g COD for the THP (using the Lystek THP) treated digestate versus 95 mL CH₄/g COD for untreated digestate).

These results provide strong evidence that the THP not only enhances the solubilization of organic matter but also improves the biodegradability of recalcitrant organic fractions of food wastes.

TABLE 2
BMP test results on untreated and THP treated food waste

| | | |
|---|---|---|
| | Untreated | Lystek THP |
| Sample | digestate | treated digestate |

Digestate 1 (BMP 1)

| | | |
|---|---|---|
| Methane yield (mL/g COD) | 97 | 131 |
| Biodegradability (%) | 28 | 37 |

Digestate 2 (BMP 2)

| | | |
|---|---|---|
| Methane yield (mL/g COD) | 95 | 116 |
| Biodegradability (%) | 27 | 33 |

In an experiment using the method of FIG. 1c, SSO waste materials were collected from a restaurant. A portion of the SSO waste, or digestate, was then treated using a THP. BMP tests were then carried out to verify the impact of treatment with the THP to improve biodegradability and biogas production.

In this current experiment, the SSO waste material was subjected to the THP at a temperature of about 75° C. and pH 8.5-9.5. Analysis of untreated and THP treated SSO waste prior to the BMP tests in the laboratory is presented in Table 3.

BMP tests on the untreated and THP treated SSO waste were conducted at 37° C., with an initial pH of 7.2-7.4, using anaerobically digested sludge obtained from a local municipal wastewater treatment plant as inoculum, at an inoculum to substrate ratio of 2. A 61% higher methane production yield per g COD for the THP treated SSO waste was observed (163 mL CH₄/g COD) compared to the corresponding per g COD for untreated SSO waste (101 mL CH₄/g COD). Similarly, the specific methane production rate for the THP treated SSO waste and untreated SSO waste were 40.5 mL CH₄/g VSS/d and 27.4 mL CH₄/g VSS/d, respectively. Thus, indicating a 48% higher specific methane production rate for the THP treated SSO material, compared to the untreated SSO material, was achieved.

TABLE 3
Characterization and BMP test results on untreated
and Lystek THP treated SSO waste

| | | Lystek THP |
|---|---|---|
| Sample | SSO waste | treated SSO |
| TS (g/L) | 88 | 77 |
| VS (g/L) | 81 | 61 |
| TSS (g/L) | 69 | 63 |
| VSS (g/L) | 67 | 60 |
| Total COD (g/L) | 146 | 123 |
| CH₄ yield (mL/g COD) | 101 | 163 |
| Specific CH₄ production rate | 27.4 | 40.5 |
| (mL/g VSS/d) | | |
| Biodegradability (%) | 29 | 47 |

In an experiment using the method of FIG. 1d, SSO waste material was collected from a restaurant. The SSO waste was pre-processed in a containerized de-packaging unit, which was effective at producing an organic slurry free of inorganic contaminants.

During the initial phase of the experiment, the SSO material supplied for anaerobic digestion provided very low biogas yields due to poor biodegradability of the recalcitrant organics of the tested SSO waste. Thus, after pre-processing in the de-packaging system, a portion of the SSO waste was further subjected to the THP to assess its impact on anaerobic digestion performance. SSO slurry was subjected to the THP at temperature 75° C. and pH 8.5-9.5 and then fed to the anaerobic digester on a daily basis.

The portion of the SSO waste that had been subjected to the THP visibly appeared more homogeneous with a significant reduction in particle size post processing. Surprisingly, the SSO waste treated with the THP had significantly higher content of soluble COD compared to the untreated SSO waste.

The experiment also included test anaerobic digesters (8 m³ volume) that were seeded and fed continuously on a 24-hour basis. Feed rates were gradually increased over a ramp-up period to acclimatize the microbial populations to the new feedstock. Volumetric COD loading of the SSO waste that was subjected to the THP ranged from 0.37 kg/m³/d to 3.02 kg/m³/d, with the initial target of a specific loading of 1.25 kg COD/m³/d to match the loading of the untreated SSO waste to the digester. A substantial positive impact of the THP was observed on the biodegradability, biogas production, methane yield of the THP treated SSO waste material. Methane yield and biodegradability for the treated SSO material was 4.7 times higher than that of the untreated SSO material.

Analysis of the untreated and Lystek THP treated SSO waste prior to feeding to the digester and impact of the THP on biodegradability and methane production is shown in Table 4.

TABLE 4
Chemical analysis and biogas production of
untreated SSO and THP treated SSO wastes

| | Untreated | Lystek THP |
|---|---|---|
| Sample | SSO waste | treated SSO |
| TS (g/L) | 40 | 70 |
| VS(g/L) | 37 | 59 |
| Total COD (g/L) | 105 | 137 |
| Soluble COD (g/L) | 16 | 36 |
| Biogas production (m³/d) | 1.34 | 1.63 |
| Biogas yield (m³/kg COD) | 0.07 | 0.33 |
| Methane yield (mL/g COD) | 43 | 204 |
| Biodegradability (%) | 12 | 58 |

The results from the above tests and experiments provide strong evidence that treating a digestate with a THP not only enhances the solubility of organic matter but also improves the biodegradability of recalcitrant food waste organics and improves biogas (methane) production. In some embodiments, THP treatment of refractory organic material present in other agricultural wastes such as, but not limited to, lignocellulosic material (corn stover, wheat straw and grasses etc.), and animal manures (cow, swine, and poultry manures etc.) may provide improvements to the processing of such organic material.

It will be appreciated by those skilled in the art that the invention can take many forms, and that such forms are within the scope of the invention as claimed. The scope of the claims should not be limited by the preferred embodiments set forth in the examples but should be given the broadest interpretation consistent with the description as a whole.

1. A method of treating recalcitrant or hard to degrade organic fractions in digested or undigested food wastes and/or source separated organic (SSO) wastes to create a more biodegradable material involving:
treating the digested or undigested food wastes and/or SSO wastes with heat, alkali, and shear for a preselected time to produce a biodegradable feedstock.

2. The method of claim 1 further comprising:
performing anaerobic digestion on the biodegradable feedstock.

3. The method of claim 1 wherein in which treatment temperature is between 70° C. and 90° C.

4. The method of claim 1 in which treatment pH is between 8 and 10.

5. The method of claim 1 in which treatment time is between 1 min and 30 min.

6. The method of claim 1 in which heat, alkali, and shear treatment can be done simultaneously or in a sequence.

7. The method of claim 2 in which anaerobic digestion time is between 5 days and 30 days.

8. The method of claim 1 further comprising pre-processing the digested or undigested food wastes and/or SSO wastes before treating the digested or undigested food wastes and/or SSO wastes.

9. The method of claim 8 wherein pre-processing the digested or undigested food wastes and/or SSO wastes comprises grinding and/or blending the digested or undigested food wastes and/or SSO wastes.

10. The method of claim 8 wherein pre-processing the digested or undigested food wastes and/or SSO wastes comprises processing the pre-processed digested or undigested food wastes and/or SSO wastes into an organic slurry.

11. The method of claim 8 wherein pre-processing the digested or undigested food wastes and/or SSO wastes comprises centrifuging the digested or undigested food wastes and/or SSO wastes into a solid portion and a liquid portion.

12. The method of claim 11 wherein treating the digested or undigested food wastes and/or SSO wastes with heat, alkali, and shear comprises treating the solid portion.
